(19) United States
(12) Patent Application Publication
(10) Pub. No.: US 2025/0356694 A1
(43) Pub. Date: Nov. 20, 2025

(54) Virtual Interaction System for Animal Accommodations

(71) Applicant: Buddy-james Auclair, Drayton Valley (CA)

(72) Inventor: Buddy-james Auclair, Drayton Valley (CA)

(21) Appl. No.: 19/208,082

(22) Filed: May 14, 2025

Related U.S. Application Data
(60) Provisional application No. 63/647,234, filed on May 14, 2024.

(51) Int. Cl. G06V 40/20; A01K 15/02; G06Q 30/0279; G06Q 30/0601; G06Q 50/00; G06V 10/764; G06V 20/40

(52) U.S. Cl. CPC G06V 40/20; A01K 15/02; G06Q 30/0279; G06Q 30/0641; G06Q 50/01; G06V 10/764; G06V 20/46

(57) ABSTRACT

A system and method for facilitating virtual human-animal interactions are disclosed in this disclosure. The system may include at least one camera unit configured to capture real-time video of an animal and an interaction module configured to perform an interactive action with the animal based on a user input. Further, an analysis module may receive user input, trigger the interaction module to perform the interactive action based on the user input, receive a real-time video of the animal from the camera unit, and feed all of it to a machine learning ML model. The ML model may be configured to detect behavior of the animal, in response to the interactive action, determine a compatibility score associated with compatibility of the animal with the user based on the behavior, and display the compatibility score on a user device.

### CROSS-REFERENCE TO RELATED APPLICATIONS/INCORPORATION BY REFERENCE

The present application claims priority to U.S. Provisional Patent Application No. 63/647,234, filed on May 14, 1122. All contents and/or relevant subject matter of the Provisional Patent Application is hereby incorporated entirely and/or wherever appropriate by reference.

### FIELD OF THE INVENTION

The present application relates to virtual communication, and more specifically relates to system and method for facilitating virtual human-animal interactions.

### BACKGROUND OF THE INVENTION

Human-animal interactions offer a wide range of physical, emotional, and mental health benefits. Companion animals such as dogs and cats are known to provide comfort, reduce stress, and promote a sense of responsibility and empathy among individuals of all ages. Especially for elderly adults and children, the presence of animals can improve well-being and social engagement. Furthermore, therapy animals are increasingly used in clinical and institutional settings to help patients achieve specific cognitive, physical, and emotional goals.

Despite these well-established benefits, existing systems and practices for enabling access to animal companionship, for example, traditional pet adoption and animal therapy programs, face several critical limitations. The conventional pet adoption model typically requires prospective adopters to physically visit shelters, interact with animals in person, and undergo screening procedures before completing the adoption. This model restricts participation to individuals who are geographically close to shelters and who are available during fixed hours for visits and bookings. The availability of shelter staff or volunteers to facilitate bookings is often inconsistent, making the process cumbersome and less responsive to users' needs.

Additionally, a significant portion of the population remains excluded from pet ownership due to constraints such as residential restrictions, frequent travel, demanding work schedules, or financial limitations. For these individuals, even though the desire to adopt or interact with animals may be strong, traditional channels offer no viable alternative. The lack of flexible, accessible systems for human-animal interaction results in lost opportunities for emotional enrichment, companionship, and therapeutic engagement.

Moreover, homes or lifestyles that are not conducive to long-term pet care often force individuals to forgo adoption altogether. This gap not only limits the potential for human benefit, but also reduces the chances of animals in shelters being meaningfully engaged or matched with suitable adopters. In the absence of scalable and personalized alternatives, these limitations continue to create barriers to the formation of human-animal bonds.

Therefore, there is a need for a systematic, accessible, and user-responsive solution that enables meaningful interaction between humans and animals, regardless of physical location or personal constraints, to enhance compatibility assessment and user experience.

### SUMMARY OF THE INVENTION

In an embodiment, a system for facilitating virtual human-animal interactions is disclosed. The system may include a camera unit configured to capture real-time video of an animal located in a shelter. The system may further include an interaction module configured to perform interactive actions with the animal based on a user input. The interaction module may include at least one of a treat dispenser or an audio-visual interface. Further, the system may include an analysis module that includes a processor and a memory. The memory stores processor-executable instructions which upon execution by the processor, cause the processor to receive, from a user, the user input, via a user interface associated with a user device. The processor-executable instructions further cause the processor to trigger the interaction module to perform the interactive action based on the user input; receive, from the at least one camera unit, a real-time video of the animal, in response to the interactive action performed via the interaction module; and feed the user input and the corresponding real-time video to a machine learning (ML) model. The ML model may be configured to: detect behavior of the animal, in response to the interactive action, based on one or more computer vision techniques; and determine a compatibility score associated with compatibility of the animal with the user, based on the detected behavior of the animal. The processor-executable instructions may further cause the processor to receive, from the ML model, the compatibility score; and display the compatibility score on a user device.

In an embodiment, the ML model may be further configured to classify the animal's behavior into predefined behavior categories upon detecting responses during interaction. Additionally, the ML model may identify video segments that correspond to each categorized behavior, potentially allowing for refined analysis and playback.

In an embodiment, the processor-executable may further cause the processor to receive a second user input for selecting a behavior classification from the plurality of predefined behavior classifications; and extract, from the real-time video, a relevant segment capturing a behavior of the animal corresponding to the selected behavior classification.

In an embodiment, the interactive action may be based on one or more user interaction metrics. The one or more user interaction metrics may include: treat dispenses via the treat dispenser or interaction duration via the audio-visual interface.

In an embodiment, the processor-executable may further cause the processor to: apply supervised or unsupervised machine learning techniques to the ML model to continuously refine accuracy of behavior classification and predictive outcomes for the compatibility score based on accumulated user input and real-time video data over time.

In an embodiment, the processor-executable may further cause the processor to: record user engagement metrics across multiple sessions. The user engagement metrics may include treat dispenses, session durations, and repeat sessions. The processor-executable may further cause the processor to award, to a user profile associated with a user, virtual rewards based on predefined interaction milestones associated with the user engagement metrics.

In an embodiment, the processor-executable further cause the processor to: enable redemption of accumulated virtual rewards for incentives by the user. The incentives may include digital recognition, exclusive content access, or monetary credits applicable to merchandise or donations. Further, the processor-executable may cause the processor to display a user standing on engagement leaderboards or community dashboards to encourage participation.

In an embodiment, the ML model may be further configured to determine a user interest score to the real-time video of the animal, for the user with respect to the animal, indicative of interest of the user in adopting the animal, based on: the user input, detected behavior of the animal, and the compatibility score. The ML model may be further configured to rank a plurality of real-time videos of the animal, based on the associated user interest scores.

In an embodiment, the processor-executable instructions may further cause the processor to tag higher ranked real-time videos of the animal across communication channels. The communication channels may include web platforms, email, or third-party platforms.

In an embodiment, the processor-executable instructions may further cause the processor to refine the machine learning model through reinforcement learning based on historical user engagement data or adoption outcomes to improve accuracy in detecting animal behavior or determining the compatibility score.

In an embodiment, the processor-executable instructions may further cause the processor to present contextual merchandise offerings to the user via the user interface based on animal profiles, user interaction history, or location data.

In an embodiment, the processor-executable instructions may further cause the processor to enable the user to initiate one-time or recurring monetary contributions via the user interface, the contributions associated with the animal or shelter performance. Further, the transactional data may be logged and stored for reporting access by authorized shelter staff via an administrative dashboard.

In an embodiment, the processor-executable instructions may further cause the processor to calculate and display dynamically adjusted donation tier suggestions on the user device based on real-time behavior analytics of the animal or system-wide trends.

In another embodiment, a method of facilitating virtual human-animal interactions is disclosed. The method may include receiving, from a user, the user input, via a user interface associated with a user device; and triggering an interaction module to perform an interactive action based on the user input, wherein the interaction module is configured to perform the interactive action with the animal based on a user input. The interaction module may include at least one of: a treat dispenser or an audio-visual interface. The method may further include receiving, from at least one camera unit, a real-time video of the animal, in response to the interactive action performed via the interaction module. The at least one camera unit may be configured to capture real-time video of the animal housed in a shelter location, for an interaction session. The method may further include feeding the user input and the corresponding real-time video to a machine learning (ML) model. The ML model is configured to: detect behaviour of the animal, in response to the interactive action, based on one or more computer vision techniques; and determine a compatibility score associated with compatibility of the animal with the user, based on the detected behaviour of the animal. Further, the method may include receiving, from the ML model, the compatibility score; and displaying the compatibility score on a user device.

In yet another embodiment, a non-transitory computer-readable medium storing computer-executable instructions for facilitating virtual human-animal interactions is disclosed. The computer-executable instructions may be configured for: receiving, from a user, the user input, via a user interface associated with a user device; and triggering an interaction module to perform an interactive action based on the user input. The interaction module may be configured to perform the interactive action with the animal based on a user input. The interaction module comprises at least one of: a treat dispenser or an audio-visual interface. The computer-executable instructions may be further configured for receiving, from at least one camera unit, a real-time video of the animal, in response to the interactive action performed via the interaction module. The at least one camera unit may be configured to capture real-time video of the animal housed in a shelter location, for an interaction session. The computer-executable instructions may be further configured for feeding the user input and the corresponding real-time video to a ML model. The ML model is configured to: detect behaviour of the animal, in response to the interactive action, based on one or more computer vision techniques; and determine a compatibility score associated with compatibility of the animal with the user, based on the detected behaviour of the animal. The computer-executable instructions may be further configured for receiving, from the ML model, the compatibility score and displaying the compatibility score on a user device.

### BRIEF DESCRIPTION OF FIGURES

The accompanying figures (FIGS.) illustrate embodiments and serve to explain principles of the disclosed embodiments. It is to be understood, however, that these figures are presented for purposes of illustration only, and not for defining limits of relevant inventions.

FIG. 1A illustrates a block diagram of a system for facilitating virtual human-animal interactions, in accordance with some embodiments of the disclosure.

FIG. 1B illustrates a schematic representation of a shelter housing the animal and implementing an interaction module, in accordance with some embodiments.

FIG. 2 is a block diagram of the system of FIG. 1 showing various components, modules, and data associated with the operation of the system, in accordance with some embodiments of the disclosure.

FIG. 3 illustrates a flowchart of a method of facilitating virtual human-animal interactions, in accordance with some embodiments of the disclosure.

FIG. 4 illustrates an exemplary computing system that may be employed to implement processing functionality for various embodiments, in accordance with some embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

The present disclosure relates to a system and method for facilitating virtual interactions between a human user and an animal housed in a shelter. The system may include various integrated components including one or more camera units configured to capture real-time video footage of the animal during a scheduled interaction session. These camera units may support various resolutions and frame rates, and may be positioned to provide an optimal field of view for observing the animal's physical movements and expressions during the session.

The system may further include an interaction module to deliver interactive stimuli to the animal based on a user-generated input. This interaction module may include a treat dispenser and/or an audio-visual interface. The treat dispenser may be configured to release edible items in a controlled manner, while the audio-visual interface may include a display screen and an audio system capable of rendering live or pre-recorded audio/video content from the user. The interaction module may be activated in real time in response to signals received from the user through a network-connected interface.

Further, an analysis module may be implemented that may include a processor and a memory configured to store executable instructions. The instructions, when executed, may cause the processor to perform various operations. These operations may include receiving user input via a user interface rendered on a user device. The user input may be in the form of commands to trigger interactive actions such as dispensing treats or initiating voice/video playback toward the animal. Upon receipt of the user input, the analysis module may transmit control instructions to the interaction module to execute the requested interactive action. Simultaneously or subsequently, video data may be streamed from the camera unit, capturing the animal's response to the interaction. This video stream, along with the user input, may be provided as input to a machine learning (ML) model. The ML model may be trained to perform behavioral analysis using computer vision techniques. For example, these techniques may include pose estimation, facial expression detection, gesture tracking, and body language interpretation.

Based on the analysis of the animal's behavior in response to the user-triggered stimuli, the ML model may determine a compatibility score. This score may represent the suitability or affinity between the user and the animal, potentially aiding decisions related to pet adoption. Thereafter, the compatibility score may be displayed on the user device in a readable and intuitive format.

Further, in some embodiments, the ML model may be configured to classify detected behavior into one or more predefined behavior categories. For example, these categories may include but are not limited to: ‘playful’, ‘curious’, ‘timid’, ‘agitated’, or ‘affectionate’. In other examples, the categories may include ‘positive’ and ‘negative’. For each classified behavior, the system may identify and tag relevant segments of the real-time video footage capturing the corresponding behavioral traits. These video segments may be stored or made accessible for later viewing or analysis by the user or shelter personnel.

The system may further support user-driven selection of specific behavior classifications, enabling targeted review of the animal's responses. For example, when the user selects a classification such as ‘affectionate’, the system may extract and present corresponding video clips where such behavior has been observed.

To enhance the accuracy of behavioral classifications and compatibility assessments over time, the ML model may be trained using supervised or unsupervised learning approaches. Training data may include historical user interactions and associated video data, enabling model refinement through iterative learning.

Additionally, the system may track user engagement metrics across multiple interaction sessions. These user engagement metrics may include: number of treats dispensed, duration of sessions, and the frequency of repeated interactions. Based on these metrics, the system may assign virtual rewards to user profiles. Rewards may be configured to unlock digital badges, access to exclusive animal content, or monetary credits for use in donations or merchandise purchases. Further, the users may be allowed to redeem accumulated rewards via the user interface. Incentive options may be configurable and may include digital recognition (e.g., top supporter badges), content privileges (e.g., behind-the-scenes footage), or financial credits applicable to pet-related merchandise or contributions to shelter operations. The system may further present dynamic engagement dashboards displaying user rankings or participation statistics to promote active involvement in the virtual adoption process. These dashboards may be accessible via web portals or mobile applications.

In some embodiments, the ML model may compute a user interest score based on the user input, the detected behavior of the animal, and the compatibility score. This user interest score may reflect the user's inclination to adopt a particular animal and may be used to rank real-time videos of the animal. In some example implementations, higher-ranked videos may be prioritized for visibility across various digital communication channels. The communication channels may include web pages, email campaigns, or third-party social media platforms.

The system may optionally utilize reinforcement learning techniques, adapting the ML model based on historical outcomes such as successful adoptions or long-term engagement trends. Such feedback may help refine behavior recognition and improve compatibility predictions.

Additionally, the system may recommend merchandise based on contextual factors such as the animal's profile, user interaction history, or geographic location. The user may be enabled to make one-time or recurring monetary contributions associated with specific animals or shelters. All transactional records may be logged and stored for authorized access by shelter administrators through a secure dashboard interface.

In some implementations, the system may dynamically compute and present donation tier suggestions to the user. These suggestions may be informed by ongoing behavioral analytics or broader system-wide interaction trends, offering a tailored and responsive donation experience.

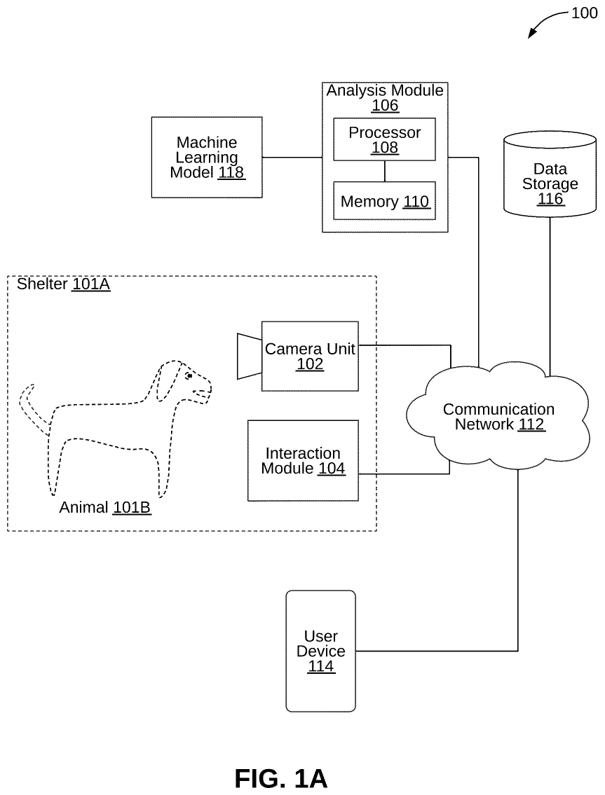

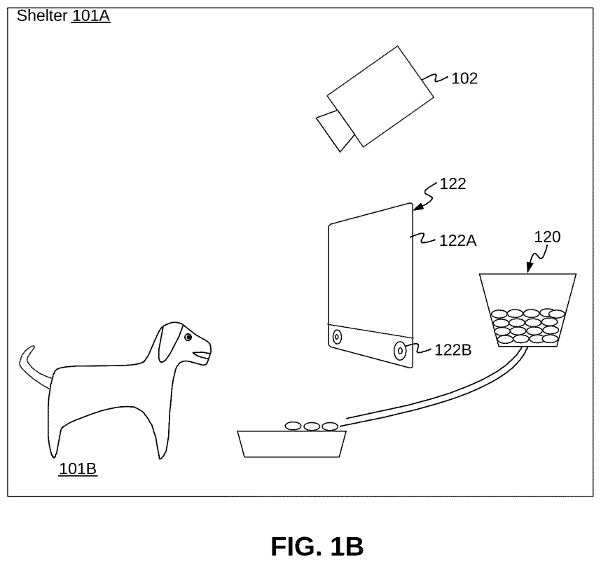

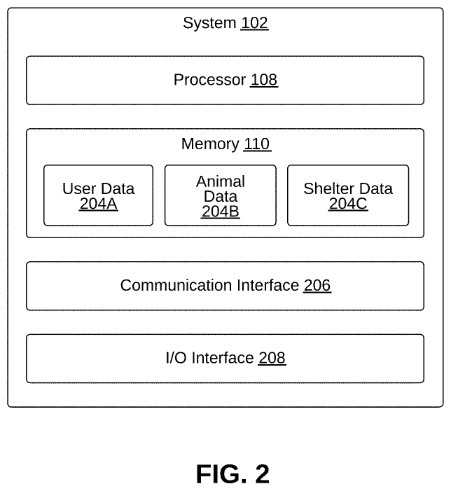

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIGS. 1A, 1B, 2, a brief description concerning the various components of the present disclosure will now be briefly discussed. Reference will be made to the figures showing various embodiments of a system for virtual interaction with the shelter animals.

Referring now to FIG. 1, a block diagram of a system 100 for facilitating virtual human-animal interactions is illustrated, in accordance with some embodiments of the disclosure. The system 100 may include a combination of hardware and software components operable to enable remote users to observe and interact with animals housed in shelters, while simultaneously analyzing animal behavior and metrics of user engagement. The system 100 may be implemented in an environment comprising at least one shelter 101A accommodating an animal 101B.

The system 100 may include at least one camera unit 102. The camera unit 102 may be strategically mounted within or adjacent to the shelter 101A such that the animal 101B remains within the field of view during an interaction session; to this end, a plurality of camera units 102 may be used. The one or more camera units 102 may be strategically installed within animal shelters, rescue facilities, foster homes, pet stores, or, in certain cases, barn stalls where animals awaiting adoption are housed. The camera unit 102 may be configured to capture real-time video of the animal 101B and stream it over a communication network to facilitate observation by a remote user. As such, the camera units 102 may be configured to capture and transmit real-time, high-resolution video feeds of the animals, thereby enabling immersive virtual interactions for prospective adopters accessing the platform via user devices. Further, in some embodiments, each camera unit 102 may optionally support one-way or two-way audio communication, allowing users not only to observe but also to audibly interact with the animals in select embodiments, enhancing the overall engagement. To this end, the system 100 may further include speakers or similar audio output devices for relaying user-generated sounds or pre-recorded messages to the animals. In some implementations, additional interactive components such as lights, lasers, or other audio-visual stimuli may be integrated to support play or enrichment activities. Recorded video sessions may subsequently be archived and made accessible through the user interface, serving as on-demand content for future viewing or promotional use.

The system 100 may further include an interaction module 104 which may be configured to perform one or more interactive actions with the animal 101B in response to a user input. In some embodiments, the interaction module 104 may include a treat dispenser that may be actuated to dispense a treat towards the animal 101B, while in other embodiments, the interaction module 104 may include an audio-visual interface capable of emitting sounds, lights, or displaying visual elements to attract or stimulate the animal 101B. The interaction module 104 may be configured to respond to commands triggered remotely by the user. This is further explained in detail in conjunction with FIG. 1B.

FIG. 1B illustrates a schematic representation of the shelter 101A housing the animal 101B and implementing the interaction module 104, in accordance with some embodiments. As shown in FIG. 1B, the system 100 may include the camera unit 102. Further, the interaction module 104 may include a food dispensing unit 120 (also referred to as treat dispenser 120), which may be configured to dispense treats or appropriate food portions to the animal 101B based on user inputs received through the interactive mobile application or website platform accessed via user devices 114. This feature allows potential adopters to engage with animals remotely by rewarding them, thereby fostering positive reinforcement and creating a meaningful sense of connection. Such interactive experiences contribute to building trust and emotional engagement between the user and the animal.

In some embodiments, the system 100 may enforce a predefined limit on the number of treats dispensed to the animal 101B within a specified time window to ensure animal safety and well-being. Furthermore, the analysis module 106 may employ algorithms to automatically categorize and organize newly added animals on the platform based on attributes such as height, weight, age, or other relevant characteristics. This automated classification facilitates efficient backend management and enhances the user experience by enabling more intuitive browsing and filtering options.

Further, the interaction module 104 of the system 100 may implement audio-visual interface 122 which may include a display 122A and one or more speakers 122B. The animal 101B may be able to engage with the user via the display 122A, as the user's face or body may be displayed to the animal 101B via the display 122A. The speakers 122B or similar audio output devices may relay user-generated sounds or pre-recorded messages to the animal 101B. In some implementations, additional interactive components such as lights, lasers, or other audio-visual stimuli may be integrated to support play or enrichment activities. Recorded video sessions may subsequently be archived and made accessible through the user interface, serving as on-demand content for future viewing or promotional use.

The system 100 may further include an analysis module 106 which may include a processor 108 and a memory 110. The memory 110 may be operable to store processor-executable instructions that, when executed by the processor 108, enable the analysis module 106 to perform various computational tasks and data analysis routines.

The analysis module 106 may be implemented on one or more remote servers configured for high-performance computing and scalable data processing. The analysis module 106 may be configured to handle data transmitted from the camera unit 102 and the interaction module 104, such as real-time video feeds, interaction logs, and user inputs. In some embodiments, the analysis module 106 may serve as a centralized processing hub for executing complex tasks, including storage, retrieval, and analysis of behavioral data captured during interactions between users and animals.

The analysis module 106 may be configured to operate as the backend engine for various client interfaces, including a mobile application and a web-based platform, ensuring smooth coordination among different system components. For example, the analysis module 106 may perform real-time processing of video streams from the camera unit 102, extract features or metrics of interest, and apply one or more machine learning models to generate user-animal compatibility scores or behavioral insights. The analysis module 106 may further implement security protocols to protect user data, including encryption mechanisms and access control policies, thereby ensuring data integrity and confidentiality. In some embodiments, the analysis module 106 may be distributed across multiple geographic locations, enabling load balancing and high availability, and optimizing response time for users regardless of their location.

In an example implementation, the camera unit 102 and the interaction module 104 may be deployed within the shelter 101A, where the animal 101B is housed. These components may be configured to locally capture and execute user-triggered interactive actions with the animal 101B. The analysis module 106, however, may be implemented remotely, for instance, on a cloud-based or centralized server infrastructure. The camera unit 102 and the interaction module 104 may communicate with the remotely located analysis module 106 via a communication network 112. This arrangement may facilitate scalable data processing and real-time interaction analytics, while allowing the shelter 101A to operate with minimal on-site computational resources.

The communication network 112 may be configured to enable data exchange among various components of the system. In particular, the communication network 112 may establish connectivity between the camera unit 102, the interaction module 104, and the analysis module 106. The communication network 112 may support transmission of real-time video streams, interaction data, and analysis results between the components. The communication network 112 may be implemented using any suitable wired or wireless technologies, and may employ standard communication protocols such as Transmission Control Protocol/Internet Protocol (TCP/IP), Hypertext Transfer Protocol Secure (HTTPS), and User Datagram Protocol (UDP). In some embodiments, the communication network 112 may include routers, gateways, or load balancers to manage data flow and optimize resource usage. Security features, such as encryption, firewalls, and access controls, may be incorporated to ensure the integrity and confidentiality of the transmitted data.

The user input may be provided by the user via a user device 114, which, for example may be a smartphone, a smartwatch, a laptop, or any other computing device. Further, a user interface associated with the user device 114 may be used by the user to provide one or more inputs to the system 100. These user inputs may include, but are not limited to, selecting an interactive action, thereby activating the interaction module 104, or submitting engagement preferences. Upon receiving the user input, the analysis module 106 may trigger the interaction module 104 to perform the corresponding interactive action.

The system 100 may include one or more user devices 114, which serve as the primary interface for end users to interact with the system. The user device 114 may include, but is not limited to, smartphones, tablets, laptops, or other computing devices capable of executing a mobile application or accessing a web-based platform. The user devices 114 may be configured to facilitate virtual interaction between users and the shelter environment, allowing users to view live video streams, engage with animals through treat-dispensing mechanisms, and participate in other interactive features. The interactive mobile application and web interface may be designed to operate across various operating systems and screen sizes, ensuring a consistent and user-friendly experience.

Once the interactive action has been performed, real-time video captured by the camera unit 102 may be relayed to the analysis module 106. The analysis module 106 may transmit the real-time video along with the user input to a machine learning (ML) model 118. As will be understood, the ML model 118 may be implemented as a software-based algorithm configured to execute one or more computer vision techniques for detecting behavioral responses of the animal 101B to the interaction.

The interactive action may be based on one or more user interaction metrics, such as treat dispenses via the treat dispenser or interaction duration via the audio-visual interface. The system 100 may track user interaction metrics such as the number of treats dispensed via the treat dispenser 120 and the duration of user interactions through the audio-visual interface 122. These user interaction metrics may inform the system's responses, ensuring that interactions are dynamic and responsive to user behavior. For example, if a user frequently dispenses treats to the animal 101B, the system 100 may prioritize that animal 101B in the user's feed or suggest related merchandise. Similarly, longer interaction durations via the audio-visual interface may indicate higher user interest, prompting the system 100 to recommend similar animals or highlight adoption opportunities.

In some embodiments, the ML model 118 may be implemented as part of the analysis module 106, and may reside on the remote server to leverage greater computational capabilities for processing video data and user inputs. The ML model 118 may be trained using supervised and/or unsupervised learning techniques to detect and classify animal behavior based on real-time video streams received from the camera unit 102. For example, the ML model 118 may utilize computer vision algorithms such as convolutional neural networks (CNNs) to identify behavioral cues like tail wagging, barking, pacing, or lying down, which may be indicative of the animal's emotional state or response to a given interactive action. Additionally, the ML model 118 may analyze patterns over time to compute a compatibility score between the user and the animal 101B. Further, in some implementations, reinforcement learning may also be employed to refine behavioral predictions and compatibility assessments based on cumulative user interactions, historical outcomes (e.g., successful adoptions), and user engagement data. This server-based architecture may allow continuous model updates and central monitoring, ensuring adaptive and scalable performance across multiple shelter locations.

For example, the ML model 118 may analyze posture, movement, facial expression, tail movement, or vocalization patterns, among other features, to determine a behavioral response. Based on this response, the ML model 118 may generate a compatibility score reflecting how compatible the animal 101B is with the interacting user. This compatibility score may then be transmitted back to the analysis module 106. The system 100 may further cause to display the compatibility score on the user device 114 via the user interface.

In some embodiments, the ML model 118 may further classify the detected behavior into one or more predefined behavior classifications. For example, these predefined behavior classifications may include ‘playful’, ‘anxious’, ‘curious’, or ‘passive’. Each classification may correspond to distinct behavioral markers. The ML model 118 may further identify a relevant segment from the real-time video, capturing a behavior of the animal 101B corresponding to each of the plurality of predefined behavior classifications. For example, the system 100 may store content featuring animals for research and behavioral analysis in a data storage 116, as shown in FIG. 1. The ML model 118 may process live video data to detect specific behaviors exhibited by the animal 101B, such as playing, eating, or resting, and classifies them into the predefined categories. The classification may help in understanding animal responses to stimuli, such as user interactions. Once the animal behavior is classified, the ML model 118 may identify and extract a relevant video segment capturing that behavior. For instance, if the behavior of the animal 101B is detected to be ‘playful’ in a segment of the video, in response to the user interactive action, the system 100 may isolate the corresponding video clip, making it available for users or shelter staff to review. Further, this feature tracks user interactions to identify animals receiving significant attention. Further, this feature enhances user engagement by providing curated content that highlights specific animal behaviors, making interactions more meaningful. For shelter staff, it offers valuable data for assessing animal temperament and suitability for adoption.

In some embodiments, a second user input may be received from the user (via a mobile application or website platform implemented on the user device 114) for selecting a behavior classification from the plurality of predefined behavior classifications. The system 100 may extract, from the real-time video, a relevant segment capturing a behavior of the animal 101B corresponding to the selected behavior classification. As such, the users can select a specific behavior classification (e.g., “playful” or “affectionate”) from a predefined list, prompting the system 100 to extract a corresponding video segment featuring the animal 101B. For example, a user interested in adopting a dog may select “playful” to view clips of the animal engaging with toy attachments. The processor 108 may retrieve the relevant segment from the real-time video feed, enhancing the user's ability to assess the animal's personality. In particular, the ML model 118 may identify relevant segments within the real-time video which capture such classified behaviors, enabling efficient review or summarization of the interaction.

In some embodiments, the system 100 may apply supervised or unsupervised machine learning techniques to the ML model 118 to continuously refine accuracy of behavior classification and predictive outcomes for the compatibility score based on accumulated user input and real-time video data over time. In particular, the processor 108 may apply supervised or unsupervised ML techniques to the ML model 118, using accumulated user inputs (e.g., treat dispenses, behavior selections) and real-time video data to refine behavior classification accuracy. Supervised learning may include training the ML model 118 with labelled data, such as videos tagged with specific behaviors. Unsupervised learning may be based on identifying patterns in unlabelled interaction data.

The system 100 may further record user engagement metrics across multiple sessions. These user engagement metrics may include: treat dispenses, session durations, and repeat sessions. Further, the system 100 may award, to a user profile associated with a user, virtual rewards based on predefined interaction milestones associated with the user engagement metrics. In other words, the system 100 may implement gamification features, to encourage sustained user engagement. The system 100 may record the user engagement metrics, such as treat dispenses, session durations, and the frequency of repeat sessions, thereby tracking user interactions. The user engagement metrics may be stored in personalized user profiles, allowing users to track their engagement history. When users achieve predefined milestones (e.g., dispensing a certain number of treats or maintaining consistent session durations), the system 100 may award virtual rewards to the users. These rewards may include badges, points, or virtual trophies for incentivizing continued participation. For example, a user who regularly interacts with a cat may earn a certain badge, enhancing their emotional connection to the platform.

Further, the system 100 may enable redemption of accumulated virtual rewards for incentives by the user. The incentives may include, for example, digital recognition, exclusive content access, or monetary credits applicable to merchandise or donations. Further, the system 100 may display a user standing on engagement leaderboards or community dashboards to encourage participation. As such, the system 100 enables users to exchange accumulated rewards for incentives, such as digital recognition (e.g., a featured profile), exclusive content access (e.g., behind-the-scenes shelter videos), or monetary credits for merchandise or donations which may be used for merchandise sales and direct purchases. Additionally, the system 100 may display user standings on leaderboards or community dashboards, visible through the interactive mobile application or website platform. The leaderboards may foster friendly competition and encourage users to increase their engagement, thereby enhancing user retention and community engagement, while providing shelters with data on top contributors, supporting promotional efforts. For instance, a user ranked highly for treat dispenses may be motivated to maintain their position, benefiting shelter animals through sustained interaction.

The ML model 118 may be further configured to determine a user interest score to the real-time video of the animal, for the user with respect to the animal, indicative of interest of the user in adopting the animal, based on: the user input, detected behavior of the animal, and the compatibility score. Further, the ML model 118 may rank a plurality of real-time videos of the animal, based on the associated user interest scores. The ML model 118 may calculate a user interest score, which quantifies a user's likelihood of adopting an animal based on the factors of user inputs (e.g., treat dispenses, behavior selections), detected animal behaviors, and the compatibility score. As such, the system 100 is capable of providing suggestions on animals based on engagement patterns. The ML model may further rank the real-time videos of the animal based on the user interest scores, prioritizing content that resonates with the user. For example, if a user frequently engages with videos of a dog playing fetch, the system 100 may rank similar videos higher, ensuring a tailored experience. This feature enhances user engagement by presenting relevant content, increasing the likelihood of adoption. Furthermore, the ranking feature may support marketing efforts for the shelter staff, by identifying high-interest animals for promotion across the platform or social media channels.

In some embodiments, the system 100 may tag higher ranked real-time videos of the animal 101B across communication channels. These communication channels may include: web platforms, email, or third-party platforms. As such, the system 100 may promote high-ranked videos across the multiple communication channels. The system 100 may tag videos with high user interest scores, making them accessible via the interactive mobile application, website platform, email campaigns, or third-party platforms (e.g., social media), helping in boosting adoption rates. For example, a video of a dog (101B) with a high interest score may be tagged for inclusion in an email newsletter or shared on the shelter's social media, increasing its visibility. Therefore, the system 100 is able to connect animals with potential adopters, enhancing adoption outcomes.

The system 100 may further refine the ML model 118 through reinforcement learning based on historical user engagement data or adoption outcomes to improve accuracy in detecting animal behavior or determining the compatibility score . . . in particular, the processor 108 may use historical user engagement data (e.g., treat dispenses, session durations) and adoption outcomes (e.g., successful adoptions) to train the model via reinforcement learning. As such, the ML model 118 is refined for accurate behavior detection or compatibility score predictions, improving its performance over time. For example, if the ML model 118 accurately predicts that a user will adopt a playful cat based on their engagement history, and the adoption occurs, the ML model 118 is reinforced, refining its predictive accuracy. As a result, the system 100 learns from real-world outcomes to enhance user-animal matches.

In some embodiments, the system 100 may be further configured to present contextual merchandise offerings to the user via the user interface based on animal profiles, user interaction history, or location data. In other words, the system 100 implements e-commerce capabilities by leveraging data-driven personalization to present merchandise offerings tailored to individual users. The system 100 may analyze data sources: animal profiles, user interaction history, and location data, to allow users to browse and purchase items like food, toys, bedding, and medical supplies directly through the mobile application or website. Additionally, the system 100 may enable selling merchandise tailored to specific animal characteristics, such as age, size, or breed.

The animal profiles may contain detailed information about each animal, such as species, breed, age, and specific needs. For example, if a user frequently interacts with a young “labrador” specie of a dog, the system 100 may suggest puppy-specific toys or food suitable for large breeds. Further, user interaction history may include metrics like treat dispenses, viewed videos, and selected behavior classifications. For example, a user who often engages with playful cats may see catnip toys or laser pointers in their recommendations. Location data may be used to influence offerings based on regional availability or shipping feasibility, ensuring practical suggestions.

The system 100 may present these offerings through the user interface of a mobile application or website implemented on the user device 114. For instance, a user browsing a dog's profile may see a pop-up suggesting a chew toy, with the suggestion informed by their history of dispensing treats to that dog. This contextual approach enhances user engagement by making the shopping experience relevant and seamless, encouraging purchases that directly support shelter animals. For shelters, this feature may help generate revenue and ensure that animals receive appropriate supplies.

Furthermore, the feature also supports the broader e-commerce ecosystem by integrating merchandise sales with the platform's role as a hub for pet-related services. By tailoring offerings, the system 100 may help strengthen user-animal connections, potentially increasing adoption interest, as users invest in items for animals they care about.

In some embodiments, the system 100 may enable the user to initiate one-time or recurring monetary contributions via the user interface. The contributions may be associated with the animal 101B or shelter performance. Further, the system 100 may log and store transactional data for reporting access by authorized shelter staff via an administrative dashboard. As such, the system 100 may enable users to make monetary contributions, by facilitating one-time or recurring donations through the user interface. These contributions can be directed toward specific animals or the shelter's overall performance, such as funding operational costs or facility improvements, thereby supporting areas without traditional shelters. For example, a user moved by a video of a kitten (i.e., animal 101B) may donate a one-time amount to fund its medical care or set up a monthly contribution to support the shelter's feeding program. To this end, the user interface may include donation buttons or forms integrated into animal profiles or shelter pages, making the process seamless.

In some embodiments, the system 100 may further log and store transactional data, such as donation amounts, frequencies, and recipient details (animal or shelter), in a secure database (e.g., the data storage 116). This data may be accessible to authorized shelter staff via an administrative dashboard, which provides real-time insights into user engagement and adoption inquiries. The dashboard may display metrics like total donations per animal or shelter, enabling staff to assess fundraising success and allocate resources effectively. For instance, if an animal (101B) receives significant donations, staff may prioritize its promotion. This feature enhances transparency and accountability, as shelters can report donation impacts to users, fostering trust and encouraging further contributions. Further, this feature supports community collaboration by connecting users with shelters, amplifying the platform's impact on animal welfare.

In some embodiments, the system 100 may calculate and display dynamically adjusted donation tier suggestions on the user device 114 based on real-time behavior analytics of the animal or system-wide trends, thereby personalizing the donation experience by dynamically adjusting suggested donation tiers. The processor 108 may calculate these tiers based on two data streams: real-time behavior analytics of the animal and system-wide trends. The results may be displayed on the user device 114. To this end, real-time behavior analytics, enabled by the ML model 118 may include analyzing the animal behavior in live video feeds. For example, if the model detects that the animal is recovering from a surgery (classified as “resting” or “low-energy”), the system may suggest higher donation tiers to cover medical expenses. Conversely, a highly active animal may prompt suggestions for lower tiers focused on toys or treats, thereby ensuring that donation suggestions reflect the animal's current needs.

Further, if many users are donating to a specific shelter due to a recent campaign, the system 100 may suggest tiered amounts that align with popular donation levels, encouraging users to match or exceed the trend. Alternatively, if donations are low system-wide, the system may propose modest tiers to boost participation. The suggestions may be dynamically adjusted, meaning they update in real-time as new data is processed. For example, a user viewing a cat's profile may see a donation prompt suggesting $10, $25, or $50, with amounts adjusted based on the cat's recent playful behavior or a surge in system-wide donations. The user device 114 may display these tiers prominently, perhaps as sliders or buttons within the donation interface, enhancing usability. This feature maximizes donation potential by aligning suggestions with user interests and shelter needs, and leverages personalized recommendations, ensuring that users feel their donations are impactful, thus fostering sustained engagement.

The disclosed system 100 offers a comprehensive digital platform which is accessible via a mobile app and website, and enables real-time, immersive interaction with shelter animals through live video feeds, interactive attachments (e.g., laser pointers, sound modules, toy activators), and treat dispensers 120. Users can virtually play, feed, and emotionally engage with animals, regardless of their location, and can even virtually adopt pets that are then cared for full-time by hired staff. This provides the benefits of companionship without the logistical burdens of ownership. Personalized user profiles, ML-based recommendations, and tracked engagement metrics enhance the user experience and help shelters optimize animal promotion and adoption efforts. Shelter staff can further engage users through live chats, video calls, and personalized content updates, fostering meaningful connections and improving adoption outcomes.

The system 100 can also support broader animal welfare by enabling pet owners to list animals for adoption or aid, hosting job opportunities for pet care professionals, and offering merchandise sales tailored to each animal. The system 100 includes data analytics and real-time dashboards to guide marketing strategies and assess platform impact. Artificial Intelligence (AI)-based bots may be implemented to streamline animal care operations in shelters. Additionally, by storing user-animal interaction data, the platform provides valuable insights for research on animal behavior. In areas lacking physical shelters, the system acts as a cost-effective alternative, promoting animal engagement and adoption through virtual means, thereby expanding access to care and companionship for animals and users alike.

FIG. 2 is a block diagram 200 of the system 100 showing various components, modules, and data associated with the operation of the system 100. FIG. 2 is to be understood in conjunction with FIGS. 1A-1B. The system 100 may include at least one processor 202 (corresponding to the processor 108), at least one non-transitory memory 204 (corresponding to the memory processor 110), an input/output (I/O) interface 206, and a communication interface 208. These components may be interconnected via one or more wired or wireless communication links. While FIG. 2 illustrates a particular arrangement of components, the scope of the present disclosure is not limited to the same; system 100 may comprise additional or fewer components so long as it performs the described functions.

The processor 202 is configured to process real-time video streams received from one or more camera units 102, strategically positioned to capture sheltered animals within an adoption center or shelter. The processor 202 ensures minimal latency and high-quality transmission to enable seamless virtual interaction between users and the animals. The processor 202 may be implemented using one or more computing hardware units, such as a microprocessor, microcontroller unit (MCU), application-specific integrated circuit (ASIC), field-programmable gate array (FPGA), digital signal processor (DSP), or a general-purpose processor. In some embodiments, processor 202 may include a multicore architecture supporting parallel processing, pipelining, and/or multithreading for efficient handling of high workloads, including video processing and analytics. Communication between the processor 202 and other components such as memory 204 may be facilitated via an internal bus.

In an example embodiment, the processor 202 is operable to execute machine-readable instructions stored in the memory 204 to perform the functionalities described herein. These may include virtual interaction handling, camera switching, treat dispensing coordination, user behavior tracking, and interface management. The processor 202 may incorporate elements such as a clock circuit, arithmetic logic unit (ALU), and supporting logic gates. Through the communication interface 208, the processor 202 may access a communication network 104 (e.g., the Internet or local network) to transmit and receive relevant data for system operation.

In another embodiment, the processor 202 may control the food dispensing unit 120. Upon receiving a signal from a remote user interface, the processor 202 activates the dispensing mechanism to reward a selected animal, thereby reinforcing user engagement.

The processor 202 may further be configured to perform analytics, tracking user interactions and preferences, and optimizing system responses to enhance the overall experience. Users accessing the system through electronic devices 106 such as smartphones, tablets, or computers can seamlessly navigate the interactive mobile application or web platform under the control of processor 202.

The memory 204 may be non-transitory and may comprise both volatile and non-volatile storage media. It may include RAM, ROM, flash memory, or other types of data storage capable of retaining digital information. The memory 204 is operatively coupled with processor 202 and is configured to store software instructions, system data, application data, and operational records, enabling the processor 202 to carry out the system's intended functions. The memory 204 may also serve as a buffer for incoming video data or user input. In some embodiments, memory 204 is organized to store specific data modules such as user data 204A, animal data 204B, and shelter data 204C.

The user data 204A stored in memory 204 may include detailed interaction histories, preference profiles, and user-specific settings related to the mobile app or website platform. Data such as video session logs, food dispensing actions, interaction timestamps, and browsing patterns are captured and stored to build personalized user profiles. These profiles enable the platform to make dynamic recommendations and enhance the interactive experience by tailoring animal suggestions or alerts to the individual user's behavior.

In an embodiment, memory 204 also stores virtual adoption certificates generated upon completion of a virtual adoption process. These certificates may be customized with the user and animal's details and are retrievable for sharing or future reference. Additionally, memory 204 may store platform analytics, such as session durations, most viewed animals, conversion rates, and engagement metrics. These data sets assist system administrators in improving the platform's functionality and user interface.

The shelter animal data 204B stored in memory 204 may include, but is not limited to, individual records for each sheltered animal containing fields such as health history, vaccination records, breed, age, color, and behavioral traits. This structured data enhances the transparency and reliability of the virtual adoption process by equipping potential adopters with essential information. Health records may include previous illnesses, treatments, or ongoing medical needs. Vaccination logs establish the animal's immunization status. Breed, age, and color information help align animal profiles with user preferences or lifestyle requirements.

The shelter home data 204C may contain metadata and operational information about the participating shelters. This includes physical addresses, contact details, available animal inventory, and food resource data. For example, a user may retrieve a shelter's location via the platform when planning a physical visit. Food availability data helps track nutrition provisions and may be used in coordination with the dispensing unit 120 to ensure adequate stock for remote treat events.

The input/output interface 206 may be configured to handle both input from and output to the user and/or system operator. This interface may include visual displays (such as LCDs, LEDs, or touchscreens), auditory outputs (e.g., speakers, buzzers), and input devices (such as microphones, cameras, touch sensors, or buttons). In some embodiments, user interface circuitry is provided to manage the display and/or speaker functions. The processor 202 may execute software instructions stored in memory 204 to control the behavior of these I/O elements.

The communication interface 208 provides wired or wireless connectivity between the system 100 and external devices or networks. In some embodiments, interface 208 includes a radio module and antenna for wireless communication (e.g., Wi-Fi, LTE, Bluetooth), allowing the system to send and receive data over the communication network 104. In other embodiments, interface 208 may support wired standards such as Ethernet, USB, or DSL. The interface may include the necessary hardware/software stacks to establish and maintain secure data connections, facilitating real-time video transmission, user authentication, and data exchange with remote devices or servers.

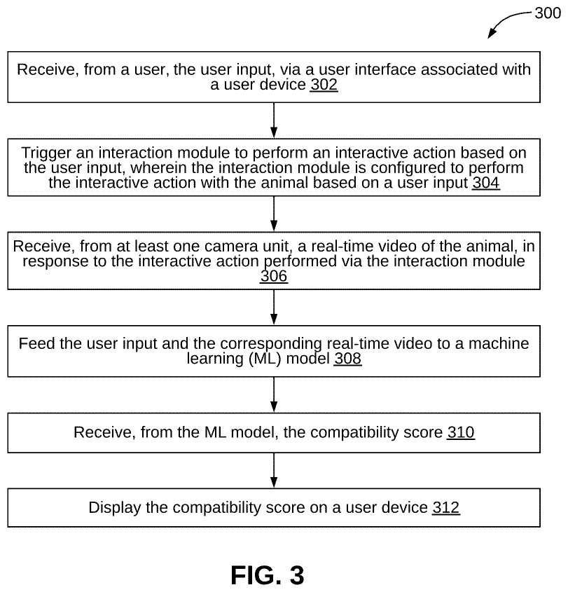

Referring now to FIG. 3, a flowchart of a method 300 of facilitating virtual human-animal interactions is illustrated, in accordance with some embodiments of the disclosure. The method 300, for example, may be performed by the processor 108 of the system 100. The method 300 leverages real-time video feeds, machine learning (ML) analytics, and user engagement metrics to create an immersive, data-driven experience that fosters emotional connections, supports animal welfare, and enhances adoption outcomes.

At step 302, the system 100 may receive user input via a user interface associated with the user device 114, such as a smartphone, tablet, or computer running the interactive mobile application or website platform. The user interface, designed to be intuitive and accessible, allows users to initiate interactions with shelter animals. For example, user inputs may include commands to dispense treats, via the treat dispenser 120.

At step 304, the system 100 may trigger the interaction module 104 to perform an interactive action based on the user input received in step 302. The interaction module 104 may include at least one of a treat dispenser 120 or an audio-visual interface 122. The treat dispenser 120 may allow users to remotely dispense food or treats to animals, fostering positive reinforcement and engagement. The audio-visual interface 122, which may include live video feeds and audio outputs, enables users to observe animals and trigger sounds or visuals to attract attention or induce play.

At step 306, real-time video of the animal may be received from at least one camera unit 102, in response to the interactive action performed via the interaction module 104. The camera unit 102, strategically placed in the shelter location, captures live footage of the animal during the interaction session. The real-time video feed allows users to engage with animals as if they were physically present, enhancing emotional connections. The configuration of the camera unit 102 may provide for high-quality, continuous streaming, enabling the system 100 to analyze animal behavior and deliver a seamless user experience.

At step 308, the user input and the corresponding real-time video may be fed to the machine learning (ML) model 118. The ML model 118 may process multimodal data to derive insights about animal behavior and user-animal compatibility. By integrating user inputs (e.g., treat dispenses) with video data, the ML model 118 captures the context of interactions, enabling sophisticated analysis.

The animal's behavior may be detected in response to the interactive action, using one or more computer vision techniques. These techniques, which may include object detection, motion tracking, or pose estimation, analyze the real-time video to identify specific behaviors, such as playing, eating, resting, or showing affection. For instance, if a user dispenses a treat, the ML model 118 may detect the animal 101B to be ‘playful’, while consuming the treat.

Additionally, after detecting an animal's behavior in response to an interactive action, the ML model 118 may classify it into one of several predefined categories, such as “playful,” “calm,” “affectionate,” or “agitated.” This classification leverages computer vision techniques, and aligns with behavioral analysis. For example, if an animal chases a laser attachment, the model may classify this as “playful,” providing a structured understanding of the animal's response.

The ML model 118 may determine a compatibility score, which quantifies the compatibility of the animal with the user based on the detected behavior. The compatibility score reflects how well the animal's responses align with the user's interaction patterns and preferences. For example, if a user frequently engages in playful interactions and the animal responds enthusiastically to the treats, the model may assign a high compatibility score, indicating a strong potential match. The compatibility score serves as a predictive metric, guiding users toward animals likely to suit their lifestyles and increasing adoption success rates. The compatibility score may be received from the ML model 118, enabling the system 100 to process and utilize this metric.

At step 310, the compatibility score may be transmitted to the analysis module 106, where it can be stored, analyzed, and displayed.

At step 312, the system 100 may display the compatibility score on the user device, providing immediate feedback to the user. The score may appear as a numerical value, percentage, or visual indicator (e.g., a heart icon with a rating) within the mobile application or website interface. For example, a user interacting with a dog may see a message stating, “Compatibility: 85%—This dog loves your playful interactions!” This step enhances user engagement by making the interaction process transparent and personalized, encouraging users to explore animals with high compatibility scores.

Additionally, the ML model 118 may identify a relevant video segment capturing the classified behavior, isolating a specific clip from the real-time feed. For example, a 10-second clip of the animal playing with a toy attachment may be extracted and tagged as “playful.”

In another embodiment, the method may further include receiving a selection from the user of a specific behavior classification and view corresponding video segments. After the ML model 118 classifies behaviors, the system 100 may receive a second user input via the user interface, where users choose from predefined categories like “playful” or “calm.” The system 100 then extracts a video segment from the real-time feed that matches the selected classification. For example, a user interested in adopting a dog may select “affectionate” to view clips of the animal nuzzling or wagging its tail.

Additionally, the method 300 may include enhancing the performance of the ML model 118 by incorporating continuous learning. The system 100 may apply supervised or unsupervised machine learning techniques to refine the model's accuracy in classifying behaviors and predicting compatibility scores. Supervised learning may involve training the model with labeled video data, where behaviors are pre-tagged, while unsupervised learning could identify patterns in unlabeled interaction data, such as recurring user inputs associated with specific animal responses. It should be noted that, over time, the model accumulates user inputs and real-time video data to improve its understanding of animal behaviors and user-animal compatibility. For example, if the ML model 118 initially misclassifies a dog's jumping as “agitated” but user feedback indicates “playful,” supervised learning corrects this error, enhancing future classifications. This continuous refinement ensures that the method remains adaptive and precise, improving user experiences and adoption success rates.

The method 300 may further include incentivizing sustained user engagement through metrics, rewards, and community features. The system 100 may record user engagement metrics across multiple interaction sessions, including treat dispenses, session durations, and repeat sessions. These metrics are stored in personalized user profiles, allowing users to track their activity. When users achieve predefined milestones, for example, dispensing 50 treats or maintaining 10 hours of session time, the system 100 may award virtual rewards, such as badges, points, or trophies. These rewards can be redeemed for incentives, including digital recognition, exclusive content access, or monetary credits for merchandise or donations. The redemption process is integrated into the user interface, ensuring accessibility. Additionally, the system may display user standings on engagement leaderboards or community dashboards, visible through the mobile application or website. This fosters friendly competition, encouraging users to increase their engagement. For shelters, this provides data on engaged users, supporting targeted adoption campaigns.

Further, the method 300 may include introducing a user interest score and video ranking system. The ML model 118 may calculate a user interest score, which quantifies the user's likelihood of adopting an animal based on user input, detected animal behavior, and the compatibility score. This score reflects the strength of the user-animal connection, guiding users toward potential adoption matches. The ML model 118 may then rank real-time videos of the animal based on these interest scores, prioritizing clips that resonate with the user. The system 100 may tag higher-ranked videos for promotion across communication channels, including the mobile application, website, email campaigns, or third-party platforms.

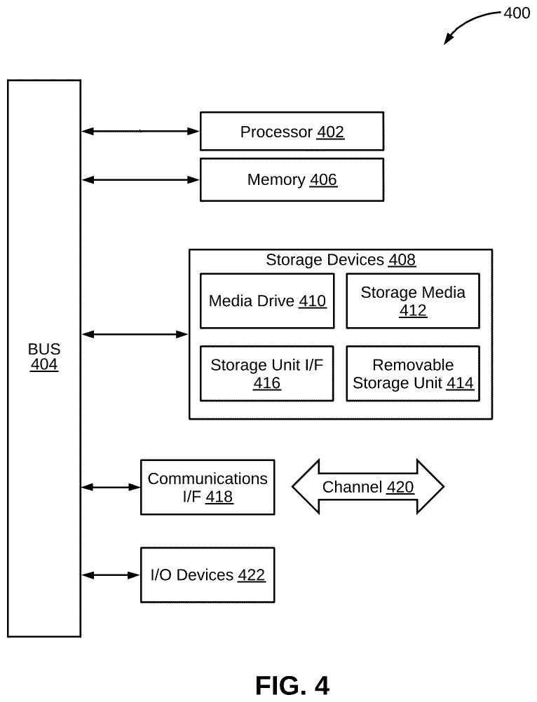

Referring now to FIG. 4, an exemplary computing system 400 that may be employed to implement processing functionality for various embodiments (e.g., as a Single Instruction Multiple Data (SIMD) device, client device, server device, one or more processors, or the like) is illustrated. Those skilled in the relevant art will also recognize how to implement the invention using other computer systems or architectures. The computing system 400 may represent, for example, a user device such as a desktop, a laptop, a mobile phone, personal entertainment device, DVR, and so on, or any other type of special or general-purpose computing device as may be desirable or appropriate for a given application or environment. The computing system 400 may include one or more processors, such as a processor 402 that may be implemented using a general or special purpose processing engine such as, for example, a microprocessor, microcontroller or other control logic. In this example, the processor 402 is connected to a bus 404 or other communication media. In some embodiments, the processor 402 may be an Artificial Intelligence (AI) processor, which may be implemented as a Tensor Processing Unit (TPU), or a graphical processor unit, or a custom programmable solution Field-Programmable Gate Array (FPGA).

The computing system 400 may also include a memory 406 (main memory), for example, Random Access Memory (RAM) or other dynamic memory, for storing information and instructions to be executed by the processor 402. The memory 406 also may be used for storing temporary variables or other intermediate information during the execution of instructions to be executed by processor 402. The computing system 400 may likewise include a read-only memory (“ROM”) or other static storage device coupled to bus 404 for storing static information and instructions for the processor 402.

The computing system 400 may also include storage devices 408, which may include, for example, a media drive 410 and a removable storage interface. The media drive 410 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 412 may include, for example, a hard disk, magnetic tape, flash drive, or other fixed or removable media that is read by and written to by the media drive 410. As these examples illustrate, the storage media 412 may include a computer-readable storage medium having stored therein particular computer software or data.

In alternative embodiments, the storage devices 408 may include other similar instrumentalities for allowing computer programs or other instructions or data to be loaded into the computing system 400. Such instrumentalities may include, for example, a removable storage unit 414 and a storage unit interface 416, such as a program cartridge and cartridge interface, a removable memory (for example, a flash memory or other removable memory module) and memory slot, and other removable storage units and interfaces that allow software and data to be transferred from the removable storage unit 414 to the computing system 400.

The computing system 400 may also include a communications interface 418. The communications interface 418 may be used to allow software and data to be transferred between the computing system 400 and external devices. Examples of the communications interface 418 may include a network interface (such as an Ethernet or other NIC card), a communications port (such as for example, a USB port, a micro-USB port), Near field Communication (NFC), etc. Software and data transferred via the communications interface 418 are in the form of signals which may be electronic, electromagnetic, optical, or other signals capable of being received by the communications interface 418. These signals are provided to the communications interface 418 via a channel 420. The channel 420 may carry signals and may be implemented using a wireless medium, wire or cable, fiber optics, or other communications medium. Some examples of the channel 420 may include a phone line, a cellular phone link, an RF link, a Bluetooth link, a network interface, a local or wide area network, and other communications channels.

The computing system 400 may further include Input/Output (I/O) devices 422. Examples may include, but are not limited to a display, keypad, microphone, audio speakers, vibrating motor, LED lights, etc. The I/O devices 422 may receive input from a user and also display an output of the computation performed by the processor 402. In this document, the terms “computer program product” and “computer-readable medium” may be used generally to refer to media such as, for example, the memory 406, the storage devices 408, the removable storage unit 414, or signal(s) on the channel 420. These and other forms of computer-readable media may be involved in providing one or more sequences of one or more instructions to the processor 402 for execution. Such instructions, generally referred to as “computer program code” (which may be grouped in the form of computer programs or other groupings), when executed, enable the computing system 400 to perform features or functions of embodiments of the present invention.

In an embodiment where the elements are implemented using software, the software may be stored in a computer-readable medium and loaded into the computing system 400 using, for example, the removable storage unit 414, the media drive 410 or the communications interface 418. The control logic (in this example, software instructions or computer program code), when executed by the processor 402, causes the processor 402 to perform the functions of the invention as described herein.

The claimed invention offers several advantages over conventional systems and methods for animal shelter engagement, particularly in facilitating meaningful and interactive virtual experiences between users and shelter animals. The system allows users to interact with shelter animals in real time via high-quality live video feeds, including options to dispense treats and engage in playful activities remotely, thereby offering a highly immersive and emotionally rewarding experience. Further, individuals unable to adopt or keep pets due to personal, health, or housing constraints can still enjoy the companionship of animals through virtual interactions, fulfilling emotional and psychological needs without physical ownership. By providing engaging, real-time interactions and showcasing animal personalities, the system increases the chances of adoption by allowing potential adopters to form emotional connections with the animals before visiting the shelter physically. The system includes an administrative dashboard that provides shelter staff with real-time insights into user engagement, adoption status updates, and animal interactions. This empowers shelters to better manage promotions and optimize adoption strategies.

The system incorporates analytics tools to study user behavior and preferences, offering shelters valuable insights into user interests and tailoring recommendations to individual users, thereby enhancing the overall experience. The system supports monetization avenues such as subscription-based interactions (e.g., hiring people to walk or care for animals), donations, and direct sale of merchandise tailored to individual animals, which can provide financial support to the shelters. Further, users can view and share animal profiles, leave comments and messages, and track their engagement history via personalized profiles. This fosters a sense of community among animal lovers and encourages repeated interactions.

Virtual interactions and treat dispensers can enrich the daily lives of sheltered animals, reducing stress and promoting healthier behavior, while shelter staff can monitor and reward animals based on engagement levels. The inclusion of one-way and two-way audio communication options provides a more interactive experience, adaptable to the specific needs of the shelter or user. Advanced search algorithms help users discover animals that match their preferences based on location, breed, age, or personality traits, facilitating more effective animal-user matching. Beyond shelters, the system allows pet owners to remotely manage care for their own pets by hiring walkers or sitters, and enables donors to fund caretaking activities for specific shelter animals. A built-in feedback mechanism ensures that the platform can evolve based on user suggestions and experiences, improving overall satisfaction and utility over time.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of functions, it should be appreciated that different combinations of functions may be provided by alternative embodiments without departing from the scope of the appended claims. In this regard, for example, different combinations of functions than those explicitly described above are also contemplated as may be set forth in some of the appended claims. Although specific terms are employed herein, they are used in a generic and descriptive sense only and not for purposes of limitation.

1. A system for facilitating virtual human-animal interactions, the system comprising:
at least one camera unit configured to capture real-time video of an animal housed in a shelter location, for an interaction session;
an interaction module, configured to perform an interactive action with the animal based on a user input, wherein the interaction module comprises at least one of: a treat dispenser or an audio-visual interface; and
an analysis module comprising a processor and a memory, the memory storing processor-executable instructions which upon execution by the processor, cause the processor to:
receive, from a user, the user input, via a user interface associated with a user device;
trigger the interaction module to perform the interactive action based on the user input;
receive, from the at least one camera unit, a real-time video of the animal, in response to the interactive action performed via the interaction module;
feed the user input and the corresponding real-time video to a machine learning (ML) model, wherein the ML model is configured to:
detect behavior of the animal, in response to the interactive action, based on one or more computer vision techniques; and
determine a compatibility score associated with compatibility of the animal with the user, based on the detected behavior of the animal;
receive, from the ML model, the compatibility score; and
display the compatibility score on a user device.

2. The system of claim 1, wherein the ML model is further configured to:
upon detecting the behavior of the animal, classify the behavior in one of a plurality of predefined behavior classifications; and
identify a relevant segment from the real-time video, capturing a behavior of the animal corresponding to each of the plurality of predefined behavior classifications.

3. The system of claim 2, wherein processor-executable further cause the processor to:
receive a second user input for selecting a behavior classification from the plurality of predefined behavior classifications; and
extract, from the real-time video, a relevant segment capturing a behavior of the animal corresponding to the selected behavior classification.

4. The system of claim 1, wherein the interactive action is based on one or more user interaction metrics, the one or more user interaction metrics comprising: treat dispenses via the treat dispenser or interaction duration via the audio-visual interface.

5. The system of claim 2, wherein processor-executable further cause the processor to:
apply supervised or unsupervised machine learning techniques to the ML model to continuously refine accuracy of behavior classification and predictive outcomes for the compatibility score based on accumulated user input and real-time video data over time.

6. The system of claim 1, wherein processor-executable further cause the processor to:
record user engagement metrics across multiple sessions, the user engagement metrics comprising: treat dispenses, session durations, and repeat sessions; and
award, to a user profile associated with a user, virtual rewards based on predefined interaction milestones associated with the user engagement metrics.

7. The system of claim 6, wherein processor-executable further cause the processor to:
enable redemption of accumulated virtual rewards for incentives by the user, the incentives comprising: digital recognition, exclusive content access, or monetary credits applicable to merchandise or donations; and
display a user standing on engagement leaderboards or community dashboards to encourage participation.

8. The system of claim 2, wherein the ML model is further configured to:
determine a user interest score to the real-time video of the animal, for the user with respect to the animal, indicative of interest of the user in adopting the animal, based on: the user input, detected behavior of the animal, and the compatibility score; and
rank a plurality of real-time videos of the animal, based on the associated user interest scores.

9. The system of claim 8, wherein the processor-executable instructions further cause the processor to:
tag higher ranked real-time videos of the animal across communication channels, the communication channels comprising: web platforms, email, or third-party platforms.

10. The system of claim 8, wherein the processor-executable instructions further cause the processor to:
refine the machine learning model through reinforcement learning based on historical user engagement data or adoption outcomes to improve accuracy in detecting animal behavior or determining the compatibility score.

11. The system of claim 1, wherein the processor-executable instructions further cause the processor to:
present contextual merchandise offerings to the user via the user interface based on animal profiles, user interaction history, or location data.

12. The system of claim 11, wherein the processor-executable instructions further cause the processor to:
enable the user to initiate one-time or recurring monetary contributions via the user interface, the contributions associated with the animal or shelter performance; and
log and store transactional data for reporting access by authorized shelter staff via an administrative dashboard.

13. The system of claim 11, wherein the processor-executable instructions further cause the processor to:
calculate and display dynamically adjusted donation tier suggestions on the user device based on real-time behavior analytics of the animal or system-wide trends.

14. A method of facilitating virtual human-animal interactions, the method comprising:
receiving, from a user, the user input, via a user interface associated with a user device;
triggering an interaction module to perform an interactive action based on the user input, wherein the interaction module is configured to perform the interactive action with the animal based on a user input, wherein the interaction module comprises at least one of: a treat dispenser or an audio-visual interface;
receiving, from at least one camera unit, a real-time video of the animal, in response to the interactive action performed via the interaction module, wherein the at least one camera unit is configured to capture real-time video of the animal housed in a shelter location, for an interaction session;
feeding the user input and the corresponding real-time video to a machine learning (ML) model, wherein the ML model is configured to:
detect behavior of the animal, in response to the interactive action, based on one or more computer vision techniques; and
determine a compatibility score associated with compatibility of the animal with the user, based on the detected behavior of the animal;
receiving, from the ML model, the compatibility score; and
displaying the compatibility score on a user device.

15. The method of claim 14, wherein the ML model is further configured to:
upon detecting the behavior of the animal, classify the behavior in one of a plurality of predefined behavior classifications; and
identify a relevant segment from the real-time video, capturing a behavior of the animal corresponding to each of the plurality of predefined behavior classifications.

16. The method of claim 15, further comprising:
receiving a second user input for selecting a behavior classification from the plurality of predefined behavior classifications; and
extracting, from the real-time video, a relevant segment capturing a behavior of the animal corresponding to the selected behavior classification.

17. The method of claim 15, further comprising:
applying supervised or unsupervised machine learning techniques to the ML model to continuously refine accuracy of behavior classification and predictive outcomes for the compatibility score based on accumulated user input and real-time video data over time.

18. The method of claim 14, further comprising:
recording user engagement metrics across multiple sessions, the user engagement metrics comprising: treat dispenses, session durations, and repeat sessions;
awarding, to a user profile associated with a user, virtual rewards based on predefined interaction milestones associated with the user engagement metrics;
enabling redemption of accumulated virtual rewards for incentives by the user, the incentives comprising: digital recognition, exclusive content access, or monetary credits applicable to merchandise or donations; and
displaying a user standing on engagement leaderboards or community dashboards to encourage participation.

19. The method of claim 15, wherein the ML model is further configured to:
determine a user interest score to the real-time video of the animal, for the user with respect to the animal, indicative of interest of the user in adopting the animal, based on: the user input, detected behavior of the animal, and the compatibility score; and
rank a plurality of real-time videos of the animal, based on the associated user interest scores,
wherein the method further comprises tagging higher ranked real-time videos of the animal across communication channels, the communication channels comprising: web platforms, email, or third-party platforms.

20. A non-transitory computer-readable medium storing computer-executable instructions for facilitating virtual human-animal interactions, the computer-executable instructions configured for:
receiving, from a user, the user input, via a user interface associated with a user device; triggering an interaction module to perform an interactive action based on the user input, wherein the interaction module is configured to perform the interactive action with the animal based on a user input, wherein the interaction module comprises at least one of: a treat dispenser or an audio-visual interface;
receiving, from at least one camera unit, a real-time video of the animal, in response to the interactive action performed via the interaction module, wherein the at least one camera unit is configured to capture real-time video of the animal housed in a shelter location, for an interaction session;
feeding the user input and the corresponding real-time video to a machine learning (ML) model, wherein the ML model is configured to:
detect behavior of the animal, in response to the interactive action, based on one or more computer vision techniques; and
determine a compatibility score associated with compatibility of the animal with the user, based on the detected behavior of the animal;
receiving, from the ML model, the compatibility score; and
displaying the compatibility score on a user device.
